(19) United States
(12) Patent Application Publication
(10) Pub. No.: US 2011/0174913 A1
(43) Pub. Date: Jul. 21, 2011

(54) Wheel winch

(76) Inventor: Glenn Smith, Missouri City, TX (US)

(21) Appl. No.: 12/583,198

(22) Filed: Aug. 17, 2009

(51) Int. Cl. B66D 1/60

(52) U.S. Cl. 242/392

(57) ABSTRACT

A wheel winch 22 for a vehicle 10 is provided. The wheel winch 22 of this invention includes a wheel drum surface engaging member 30, having a plurality of spaced aligned apertures 32 formed therein, for coupling to a drive wheel 14 of the vehicle 10. A hollow spool 36 is provided to be coupled to the wheel drum surface engaging member 30. The wheel drum surface engaging member 30 is coupled to the wheel 14 of the vehicle 10 with threaded studs 52 coupled in the apertures 32 and secured thereto by the threaded nuts 54. The spool 36 is also provided with a coupling slot 44 formed therein. Additionally, the wheel winch 22 is provided with a cable 26 having a first slot engaging member 46 at one end thereof for couplingly engaging the cable in the slot 44 of the spool 36 and a second engaging member 48 at another end thereof for coupling the cable around a stationary object 50. This allows the vehicle 10 to be pulled from a mired condition when the vehicle drive wheel 14 is rotated.

### TECHNICAL FIELD

This invention relates to a winch and more particularly to a wheel winch to be used as a specific component with a vehicle wheel. The vehicle wheel of course is a necessary component to facilitate motion of a vehicle. Sometimes however additional components are necessary to assure motion of a vehicle wheel when the vehicle gets immobilized such as when a vehicle is trapped in mud, snow or such other undesirable conditions. This is a situation of utmost concern particularly because of the safety implications for the vehicle as well as any persons that may be traveling in the vehicle. This ongoing concern for safety dictates that vehicles from time to time require the use of a winch to assist in freeing a vehicle from such conditions. Thus motorist have to consider various alternatives to assure that when such conditions exists they can immediately address the situation. One of the popular alternatives for motorist in this situation is the use of wheel winch mechanisms and the like.

Such devices are normally mountable to the vehicle wheels. Additionally, they may be power driven devices and frequently are even hand driven. Still further they are likely associated with more than one wheel on the vehicle, and frequently permanently mounted on at least one wheel. These wheel devices can be quite complicated and are expensive and not always easy to use.

Accordingly it is desirable to have a device that can be used on one wheel of the vehicle that is uncomplicated in its construction thereby making it inexpensive and easy to use.

### BACKGROUND ART

Attempts have been made to provide devices to facilitate wheel winch assemblies. One such device is illustrated in U.S. Pat. No. 6,095,451. In this arrangement two of the vehicle wheels must be used. The wheel winch of this invention includes a plurality of spaced brackets which are fastened to the surface of the drive wheel of the vehicle. The brackets include a plurality of retractable fingers which are provided to engage and support a rope thereon. Still another bracket is attached to a non-drive wheel of the vehicle. This bracket cooperates with the brackets on the drive wheel and the rope, to facilitate the action of the winch and accomplish its objective when in operation. Another apparatus is disclosed in U.S. Pat. No. 4,778,126. This invention discloses a wheel winch having a first hub assembly attached to a drive wheel of the vehicle and a second hub assembly fixedly attached to a non-drive wheel of the vehicle. The first and second hub-assemblies cooperate with a cable to facilitate the winch action of the invention. Although devices such as these may achieve the desired result these kinds of structures may be considered somewhat complex. Additionally they require that two wheels of the vehicle be used to accomplish the desired result, and frequently has portions permanently fixed to the vehicle. Thus the commercial viability remains to be seen. Therefore there is an ongoing need for a wheel winch that is uncomplicated structurally, and low in cost while still providing a safe method for aiding in pulling a vehicle from a mired condition.

### DISCLOSURE OF THE INVENTION

A wheel winch for a vehicle is provided. The wheel winch of this invention includes a spool assembly for coupling to a wheel of a vehicle. The spool assembly is provided with a longitudinally extending opening formed therethrough and a wheel drum surface engaging member having a plurality of spaced aligned apertures formed therein at an outermost end thereof. The wheel drum surface engaging member is provided to facilitate the coupling engagement of the spool assembly to the wheel of the vehicle. The spool assembly is also provided with a spool affixed between spaced end members one of which is aligned with and coupled to the surface engaging member. The spool is provided with a coupling slot formed therein. Additionally, the wheel winch of this invention is also provided with a cable having a first slot engaging member at one end thereof for couplingly engaging the cable in the slot of the spool, and a second engaging member at another end thereof for facilitating coupling of the cable to a stationary object.

### BRIEF DESCRIPTION OF THE DRAWING

The details of the invention will be described in connection with the accompanying drawing in which:

FIG. 1 is a perspective view illustrating a wheel winch in accordance with the principles of the invention shown in combination with a vehicle.

FIG. 2 is a perspective view of the wheel winch in accordance with the principles of the invention.

FIG. 3 is a end view of a wheel winch illustrated in FIG. 2 in accordance with the principles of the invention.

FIG. 4 is a side view of the wheel winch illustrated in FIG. 2 in accordance with the principles of the invention.

FIG. 5 is another end view of the wheel winch illustrated in FIG. 4 in accordance with the principles of the invention.

FIG. 6 is a front view of the wheel winch in FIG. 2 aligned with a vehicle wheel drum and illustrating the coupling arrangement of the winch of the wheel in accordance with the principles of the invention.

FIG. 7 is another front view of the wheel winch illustrated in FIG. 2 aligned with and coupled to a vehicle wheel in accordance with the principles of the invention.

FIG. 8 is a perspective view of a spool assembly of a second embodiment of a wheel winch in accordance with the principles of the invention.

FIG. 9 is an end view of the spool assembly of a wheel winch illustrated in FIG. 8 in accordance with the principles of the invention.

FIG. 10 is a front view of the spool assembly of a wheel winch illustrated in FIG. 8 in accordance with the principles of the invention.

FIG. 11 is an end view of the spool assembly of a wheel winch illustrated in FIG. 10 in accordance with the principles of the invention.

FIG. 12 is a front view of the wheel winch in FIG. 8 aligned with a vehicle wheel drum illustrating the coupling arrangement of the winch to the wheel drum in accordance with the principles of the invention.

FIG. 13 is another front view of the wheel winch illustrated in FIG. 8 aligned with and coupled to a vehicle wheel in accordance with the principles of the invention.

FIG. 14 is a perspective view of a spool assembly of a third embodiment of a wheel winch in accordance with the principles of the invention.

FIG. 15 is a end view of the spool assembly of a wheel winch illustrated in FIG. 14 in accordance with the principles of the invention.

FIG. 16 is a front view of the spool assembly of a wheel winch illustrated in FIG. 15 in accordance with the principles of the invention.

FIG. 17 is an end view of the spool assembly of a wheel winch illustrated in FIG. 16 in accordance with the principles of the invention.

FIG. 18 is a front view of a third embodiment of a wheel winch aligned with and coupled to a vehicle wheel in accordance with the principles of the invention.

FIG. 19 is a side view of a spool assembly of a fourth embodiment of a wheel winch aligned with a vehicle wheel drum and illustrating a coupling arrangement of the winch on the wheel drum in accordance with the principles of the invention.

FIG. 20 is an end view of the spool assembly of a wheel winch in FIG. 19 in accordance with the principles of the invention.

FIG. 21 is a perspective view illustrating a fifth embodiment of a wheel winch in accordance with the principals of this invention shown in combination with a vehicle.

FIG. 22 is a perspective view of the cable assembly illustrated in FIG. 21 in accordance with the principles of the invention.

FIG. 23 is a perspective view of a cable feed bar illustrated in FIG. 22 shown in conjunction with portions of the cable assembly in accordance with the principles of the invention.

FIG. 24 is a back side view of the cable feed bar illustrated in FIG. 22 in accordance with the principles of the invention.

FIG. 25 is an end view of the cable feed bar illustrated in FIG. 24 in accordance with the principles of the invention.

FIG. 26 is a front side view of the cable feed bar illustrated in FIG. 24 in accordance with the principles of the invention.

### BEST MODE FOR CARRYING OUT THE INVENTION

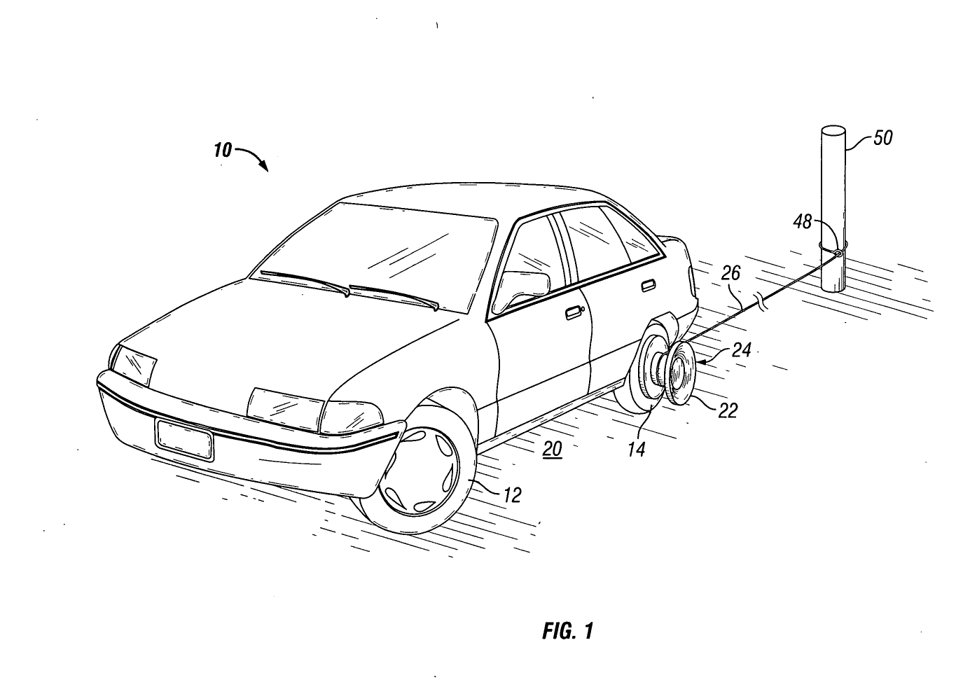

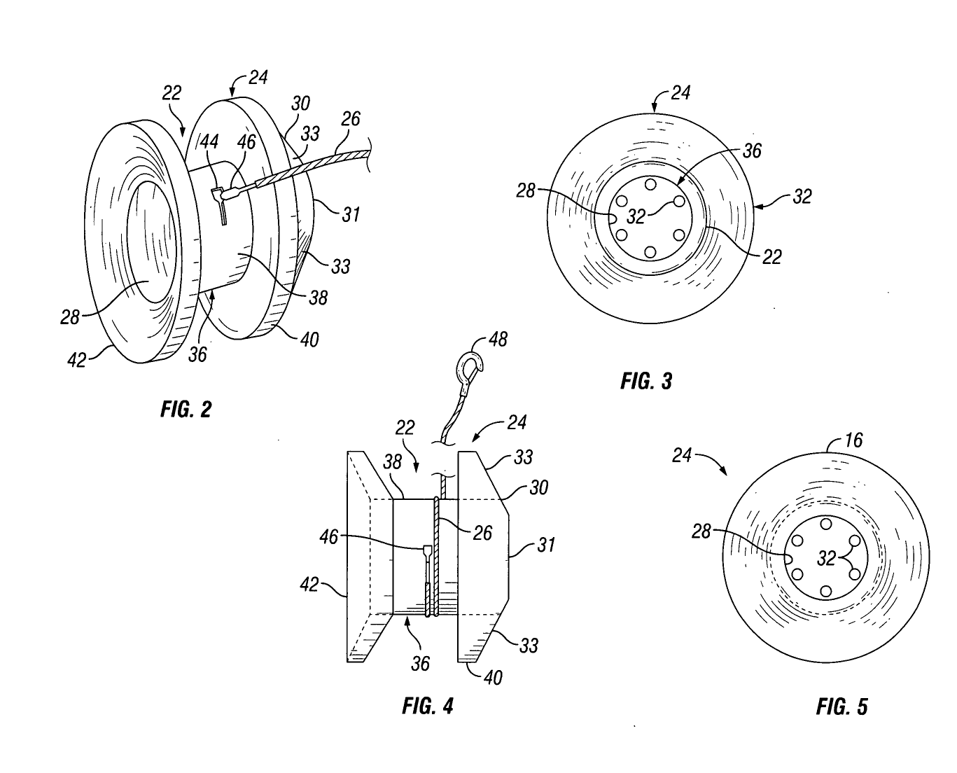

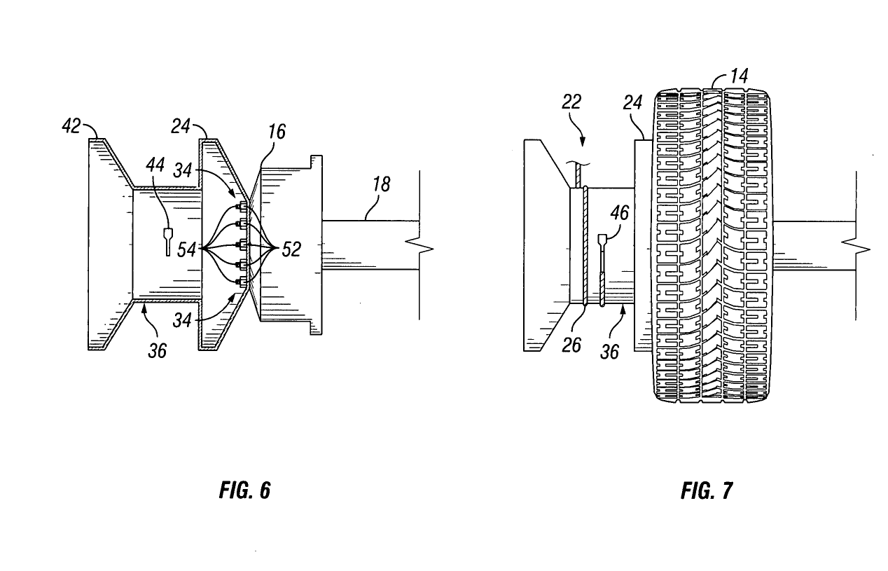

Referring to FIGS. 1 through 7 there is shown, an automobile, generally designated, by the numeral, 10. The automobile 10 is provided with front and rear wheels, generally designated, by the numerals, 12 and 14 respectively. In the typical rear wheel drive vehicle the front wheel 12 is the driven wheel and the rear wheel 14 is the drive wheel. The front and rear wheels 12 and 14 are mounted to the vehicle 10 by wheel drums 16 which are supported on the car axle 18 (FIG. 6) in a well known manner so that the wheels engage a road surface 20 and facilitate the motion of the automobile 10.

The automobile 10 is provided with a wheel winch generally designated, by the numeral, 22 which is coupled to the rear drive wheel 14 of the automobile. The wheel winch 22 includes a spool assembly, generally designated, by the numeral 24 and a cable, generally designated, by the numeral 26 couplable at one end thereof to the spool assembly.

As illustrated the spool assembly 24 is provided with a longitudinally extending opening 28 which extends through the length of the assembly. The spool assembly 24 is also provided at one end thereof with a wheel drum mounting and engaging member, generally designated, by the numeral 30. The mounting and engaging member 30 is provided with an intermediate circular shaped mounting member 31 having a plurality of spaced aligned apertures 32 (FIG. 3) formed therein, and diagonally extending support members 33 coupled to and extending from the intermediate mounting member. Each one of the plurality of apertures 32 are provided to receive and engage a selected one of bolt stud members, generally designated, by the numeral 34 (FIG. 6) of the wheel drum 16 when the engaging member is couplably aligned adjacent to the drum.

The spool assembly 24 is provided with a spool, generally designated, by the numeral, 36 having upstanding circularly shaped end members 40 and 42. The end member 40 is coupled to the diagonally extending support members 33 of the mounting and engaging member 30 and along with the end member 42 allows the cable to be wound and supported on the spool in a predetermined manner. The spool 36 also includes a cable coupling slot 44.

The cable 26 includes a coupling plug 46 coupled to one end thereof for couplingly engaging the spool 36 with the coupling slot 44. Another end of the cable 26 is provided with a cable hook 48 (FIG. 4) which allows the cable to be coupled to a stationary object, such as for example, a post 50 (FIG. 1).

When it is desired to use the wheel winch 22, the wheel nuts 52 of the bolt stud assembly 24 are removed from the wheel drum 16, so that the drum mounting and engaging member 30 is aligned adjacent the drum. The member 30 is aligned so that the apertures 32 are in adjacent engaging alignment over an adjacent wheel stud 54 of the wheel drum 16. The wheel nut 52 provided for each stud 54 can then be threadedly coupled to the stud so that the spool assembly 24 is coupled to the wheel drum 16. The cable coupling plug 46 is then coupled into the slot 44. The cable hook 48 at the other end of the cable 26 can then be coupled around the stationary object such as, for example the post 50. Once this is done the automobile can be started and once the drive wheels 14 began to turn the cable 26 will be wrapped around the spool 36 in a predetermined manner. This causes the automobile 10 to be pulled out of what ever mired condition it maybe be in.

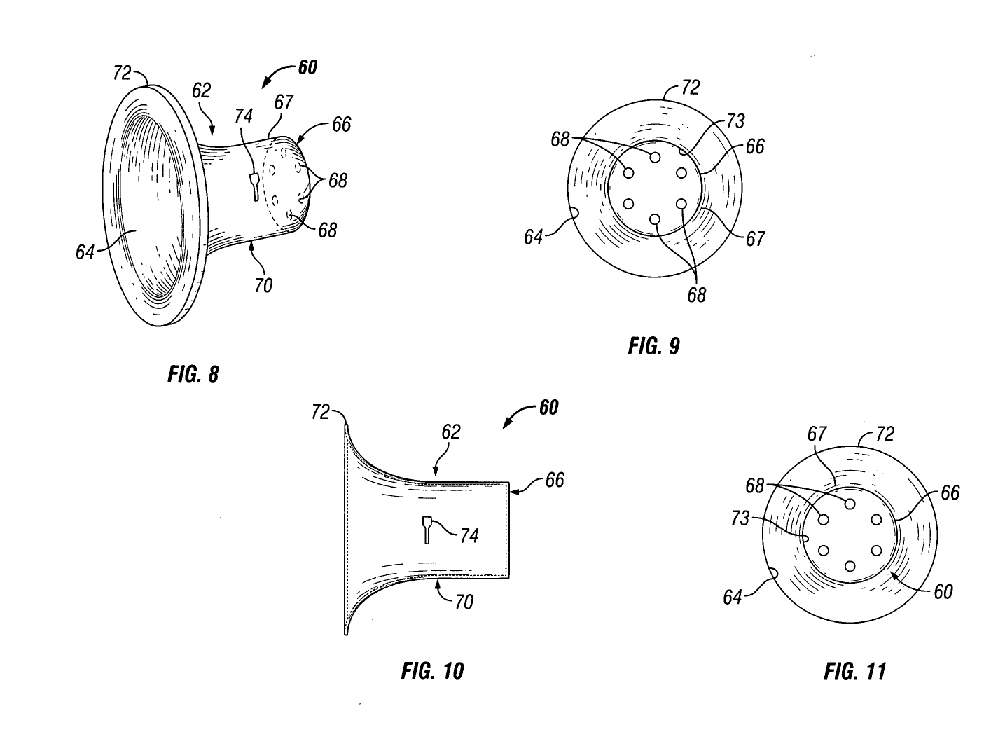

A second embodiment of the invention is illustrated in FIGS. 8 through 13.

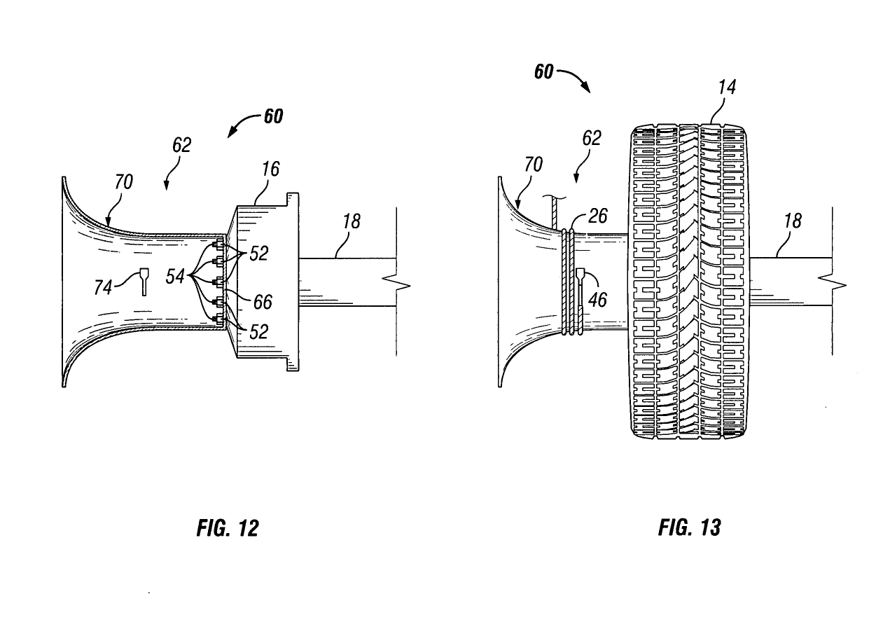

This embodiment discloses a wheel winch 60 having a spool assembly 62 having a longitudinally extending opening 64 which is mountable from inside the assembly. A wheel drum mounting and engaging member, generally designated, by the numeral 66 is provided at one end of the spool assembly 62. The mounting and engaging member 66 includes a circularly shaped mounting member 67 having a plurality of spaced aligned apertures 68 formed therein. Each one of the plurality of apertures 68 are provided to engage and be coupled to a selected one of the studs 54 of the wheel drum 16 (FIG. 12). The spool assembly 62 is provided with a spool, generally designated, by the numeral 70 having a circular shaped end member 72, and an open end 73 inside of which the mounting member 67 of the engaging member 66 is coupled. The spool 70 also includes a cable coupling slot 74. In this embodiment the end member 72 and the wheel drum provide spaced abutting surfaces to allow the cable 26 (FIG. 13) to be wrapped around the spool 70 in a predetermined manner. This embodiment of the invention allows the coupling of the spool assembly from inside of the longitudinally extending opening 64 (FIG. 13). As a result the spool can be very hollow and lighter in weight thereby facilitating easier mounting to the drum 16.

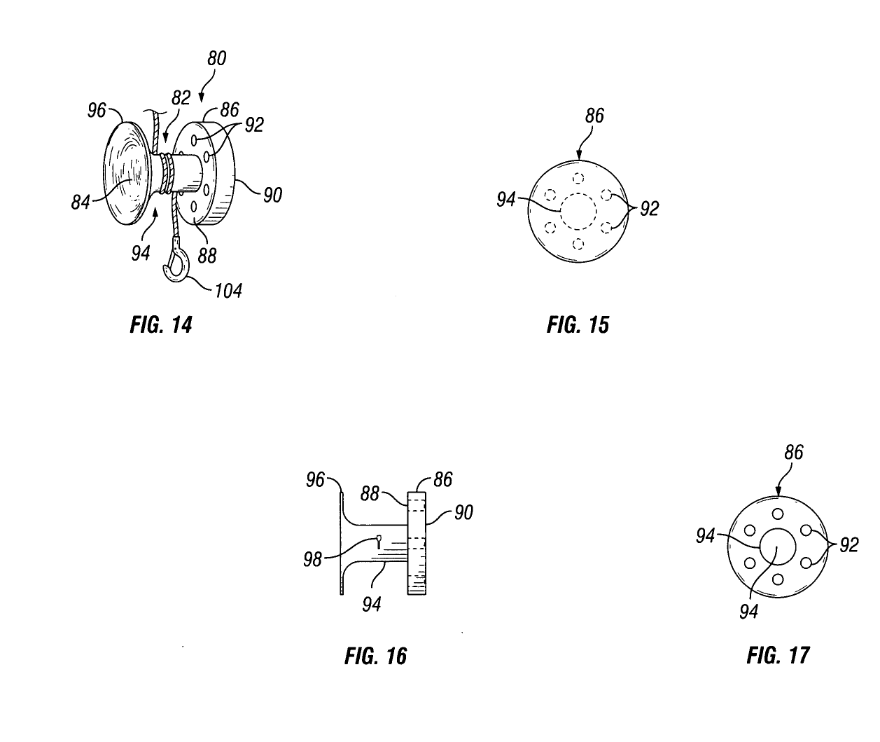

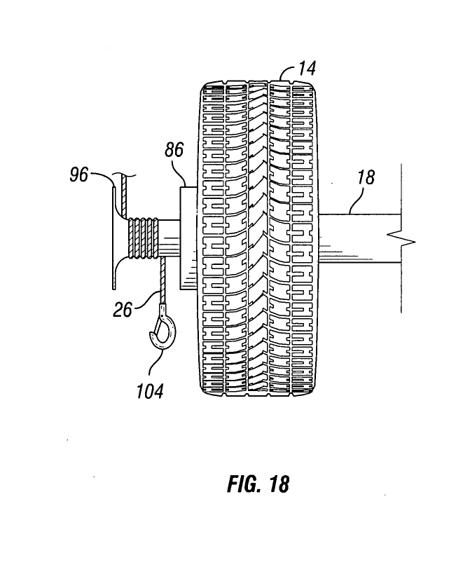

A third embodiment of the invention is illustrated in FIGS. 14 through 18.

In this embodiment as illustrated a wheel winch, generally designated, by the numeral, 80 is provided having a spool assembly, generally designated, by the numeral, 82. The spool assembly 82 is provided with a longitudinally extending opening 84. The spool assembly 82 of this embodiment of the invention is provided at one end thereof with a circular shaped wheel drum mounting and engaging member, generally designated, by the numeral 86. The circular shaped mounting and engaging member 86 is provided with spaced aligned inside and outside surfaces 88 and 90, respectively, having a plurality of spaced aligned apertures 92 formed therein. The surface 90 is alignable to adjacently engage the wheel drum 16. Each one of the plurality of apertures 92 are provided to engage a selected one of the stud members 54 of the wheel drum 16. This spool assembly 82 is provided with a spool, generally designated, by the numeral 94. The spool 94 has one end thereof coupled to the inside surface 88 of the circular shaped engaging member 86, and is formed at the other end thereof with an upstanding circular shaped member 96.

The spool also includes a cable coupling slot 98 for receiving the cable 100 and along with the surface 88 and upstanding member 96 facilitate the orderly winding of the cable onto the spool.

The cable 100 includes a coupling plug (not shown) which couplingly engages the slot 98 of the cable to allow coupling of the cable to the spool 94. The other end of the cable 100 is provided with a cable hook 104 which allows the cable to be coupled to a stationary object, such as, for example the post 50 (FIG. 1).

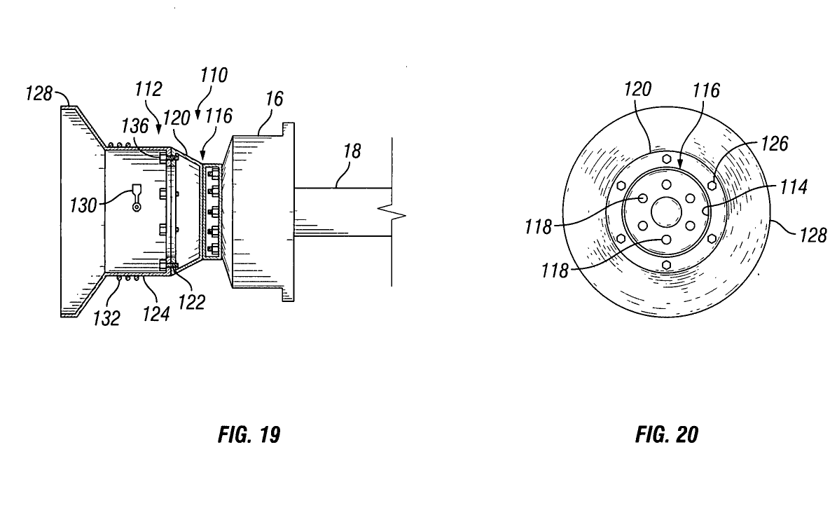

A fourth embodiment of the invention is illustrated in FIGS. 19 and 20.

In this embodiment a winch assembly, generally designated, by the numeral, 110 is provided having a bifurcated spool, assembly, generally designated, by the numeral, 112. The spool assembly 112 is provided with a longitudinally extending opening 114 which extends through the length of the assembly. The spool assembly 112 is also provided at one end thereof with a circular shaped wheel drum mounting and engaging member, generally designated, by the numeral 116. The mounting and engaging member 116 is provided with a plurality of spaced aligned apertures 118 formed therein. Each one of the plurality of apertures 118 are provided to engage a selected one of the studs 54 of the wheel drum 16. The mounting and engaging member 116 is provided with a support and mounting flange 120. The support and mounting flange includes threaded apertures 122. The spool assembly 112 is provided with a spool 124 having threaded apertures 126 formed therein at one end thereof and a diagonally projecting circularly shaped end member 128 at the other end thereof. The spool 122 includes a coupling slot 130 so that a cable 132 can be coupled to and around the spool in a predetermined manner.

The apertures 126 of the spool 124 are alignable adjacent to apertures 122 in the support flange 120 so the spool and flange can be threadedly coupled to each other by bolts 136. The bifurcated structure of this embodiment permits an easier mounting of the winch to the wheel.

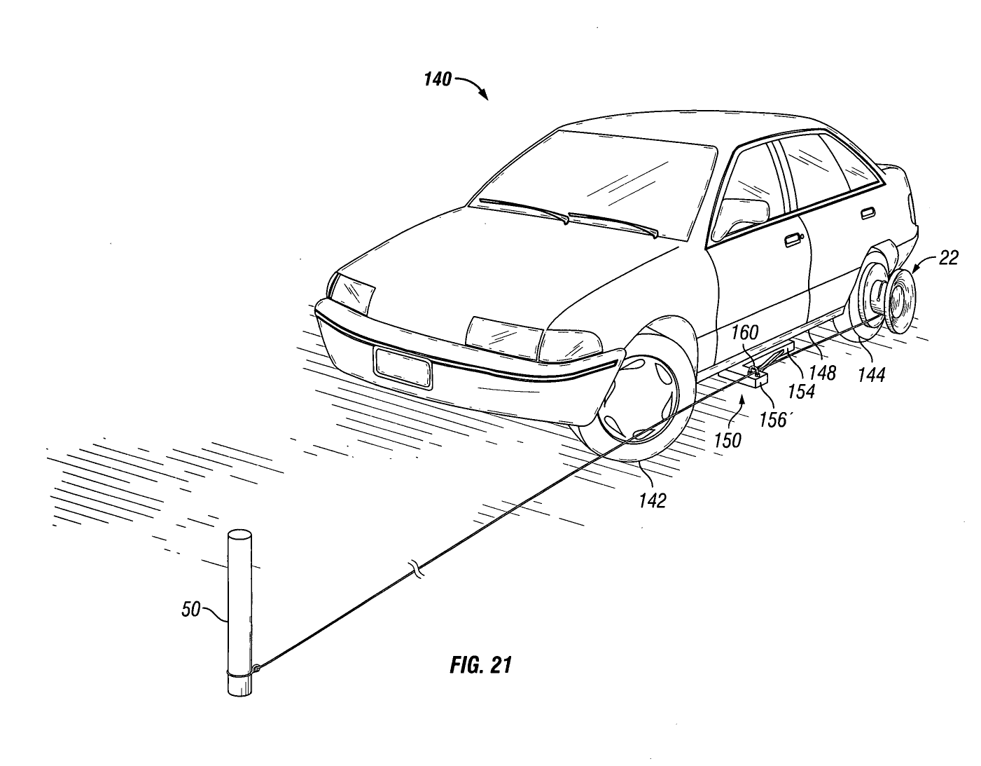

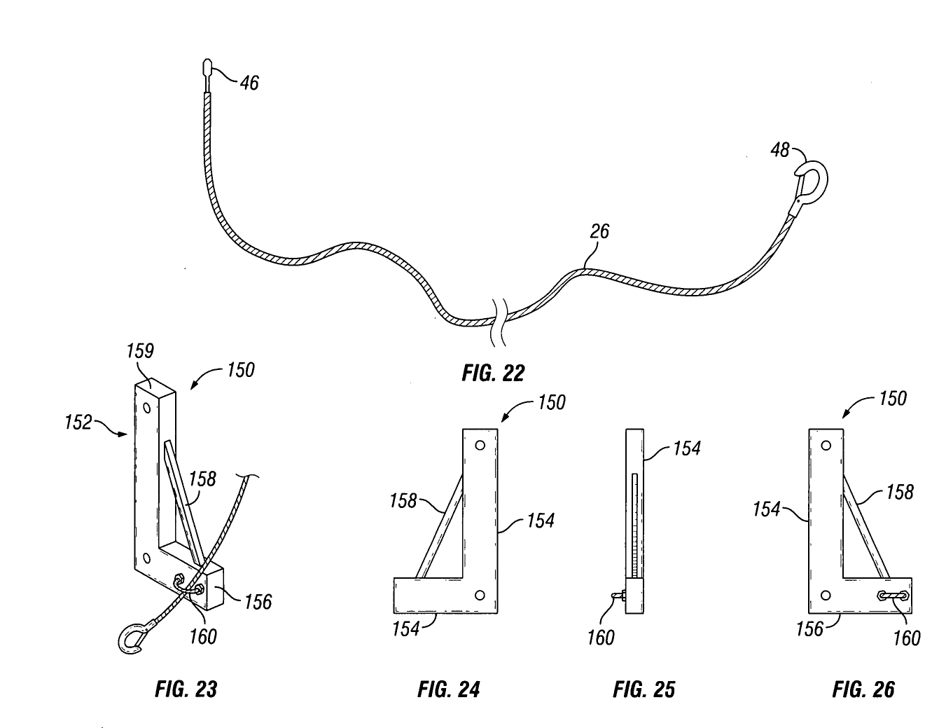

A fifth embodiment of the invention is illustrated FIGS. 21 through 26.

Referring to FIGS. 21-26 there is shown, an automobile, generally designated, by the numeral, 140. The automobile 140 is provided with front and rear wheels, generally designated, by the numeral, 142 and 144 respectively.

The automobile 140 is provided with a wheel winch which may be, for example, the winch 22, illustrated in the first embodiment or either of the other embodiments previously described in the invention.

In this embodiment the wheel winch 22 is provided with a cable feed bar, generally designated, by the numeral, 150 mountable to the frame undercarriage 148 of the automobile. The cable feed bar 150 may be, for example bolted to the undercarriage 148 of the automobile or secured in some other well known manner. The cable feed bar 150 includes a support member 152 having perpendicularly coupled arms 154 and 156. A cross bar 158 is diagonally coupled between the arms 154 and 156. A cable guide 160 is mounted on an upper surface of the arm 156.

The cable feed bar 160 is used when the vehicle is stuck in a manner so that access to the stationary object is only available in front of the vehicle. When this is the case the cable 26 is fed from the spool assembly 24 through the cable guide 160 of the cable feed bar 150 to the front of the vehicle and then coupled to the stationary object 50. Once this is done the car can be started to allow the winch to remove the car from its mired condition.

The cable used in this invention is a safety cable made, for example, of a heavy gauge steel. This heavy gauge steel cable is designed to support the weight of the particular vehicle it is being used with.

The cable spool of this invention is designed to hold the safety cable, while the vehicle is being pulled to safety. The spool is designed with a high sloped outside end member and straight inside walls to help guide and tightly gather the cable thus keeping the cable from slipping off of the spool during the winching process.

The mounting and engaging member of the invention is the base and anchor of the spool assembly. It can be made as part of the spool or could also be made as a separate and connecting part of the spool. This member as illustrated herein mounts and attaches to the vehicle by using the vehicle drum and axle. It is also made to fit a specific vehicle and wheel for best performance and safety.

The cable spool and mounting and engaging member may be made of a variety of different metals depending on the particular vehicle type and the strength of material required as a result.

It should be understood that the embodiments illustrated herein are designed so that there are a variety of structural configurations to fit a variety of different vehicles. A particular embodiment of course may be more suitable for one vehicle type than another depending on the specific design and specification of the vehicle.

The invention has been shown and described in what is considered to be the most practical and preferred embodiments. However, it should be recognized that changes may be made by those skilled in the art without departing from the spirit and scope of the invention.

What is claimed:

1. A wheel winch for a vehicle including:
a first hollow elongated means couplable for rotation with a wheel of the vehicle about a parallel axis thereof;
means coupled to the first elongated means, for engaging a predetermined surface of a drive wheel of the vehicle;
means for coupling the wheel surface engaging means to the drive wheel of the vehicle for rotation thereon; and
a second elongated means, couplable to the first elongated means and a stationary member, for progressively securing the first elongated means around the periphery thereof so that the vehicle can be pulled from a mired condition when the drive wheel of the vehicle is rotated in a predetermined manner.

2. A wheel winch as defined in claim 1 wherein the first elongated means includes a coupling aperture formed in an intermediate portion thereof.

3. A wheel winch as defined in claim 2 wherein the second elongated means includes:
a first means for couplingly engaging the coupling aperture in the first elongated means so that the second elongated means is coupled thereto; and
a second means for couplingly engaging the second elongated means around the stationary member so that the second elongated member is coupled thereto.

4. A wheel winch as defined in claim 3 wherein the wheel surface engaging means includes a plurality of spaced aligned apertures formed therein.

5. A wheel winch as defined in claim 4 wherein the wheel surface engaging coupling means includes:
first portions thereof coupled to the drive wheel of the vehicle for aligned engagement in the apertures in the wheel surface engaging means; and
second portions thereof for coupling to the aligned aperture engagement means so that the wheel surface engaging means is coupled for rotation to the drive wheel of the vehicle.

6. A wheel winch as defined in claim 5 wherein the first elongated means includes a spool having a longitudinally extending opening formed therethrough, spaced circularly shaped end members coupled at opposite ends thereof and a coupling slot formed in an intermediate portion of the spool.

7. A wheel winch as defined in claim 6 wherein the wheel surface engaging means includes:
an intermediate circular shaped mounting member having apertures formed around the periphery thereof; and
diagonally extending supporting members coupled to extend from the mounting member into coupling engagement with the adjacently aligned end member of the spool.

8. A wheel winch as defined in claim 7 wherein the second elongated means includes:
a cable having a first slot engaging member at one end thereof for couplingly engaging the cable in the slot of the spool and a second engaging member at another end thereof for coupling the cable to the stationary object.

9. A wheel winch as defined in claim 8 wherein the first slot engaging member is a coupling plug and the second engaging member is a cable hook.

10. A wheel winch as defined in claim 9 wherein the first portions of the surface engaging coupling means includes a plurality of spaced threaded studs projecting outwardly from the drive wheel, each one of the studs being alignable in a corresponding one of the apertures in the wheel surface engaging means.

11. A wheel winch as defined in claim 10 wherein the second portions of the surface engaging coupling means includes a plurality of wheel nuts, each one of the wheel nuts being threadedly couplable to a corresponding one of the studs of the surface engaging coupling means so the surface engaging means is coupled for rotation to the wheel of the vehicle.

12. A wheel winch as defined in claim 3 wherein the first elongated means further includes a spool having a longitudinally extending opening formed therethrough, a circularly shaped end member coupled to one end of the spool opposite the wheel surface engaging means and a coupling slot formed in an intermediate portion of the spool.

13. A wheel winch as defined in claim 12 wherein the wheel surface engaging means further includes a circularly shaped mounting member having a plurality of spaced coupling apertures formed therein coupled in the longitudinal opening in the spool in another end of the spool.

14. A wheel winch as defined in claim 13 wherein the second elongated means includes a cable having a first slot engaging member at one end thereof for couplingly engaging the cable in the slot of the spool and a second engaging member at another end thereof for coupling the cable to the stationary object.

15. A wheel winch as defined in claim 14 wherein the first slot engaging member is a coupling plug and the second engaging member is a cable hook.

16. A wheel winch as defined in claim 15 wherein the wheel surface engaging coupling means includes:
first portions thereof coupled to the wheel of the vehicle for aligned engagement in the apertures in the wheel surface engaging means; and
second portions thereof for coupling to the aligned aperture engagement means so that the wheel surface engaging means is coupled for rotation to the drive wheel of the vehicle.

17. A wheel winch as defined in claim 16 wherein the first portions of the surface engaging coupling means includes a plurality of spaced threaded studs projecting outwardly from the drive wheel, each one of the studs being alignable in a corresponding one of the apertures in the wheel surface engaging means.

18. A wheel winch as defined in claim 17 wherein the second portions of the surface engaging coupling means includes a plurality of wheel nuts, each one of the wheel nuts being threadedly couplable to a corresponding one of the studs of the wheel surface engaging coupling means so the surface engaging means is coupled for rotation to the wheel of the vehicle.

19. A wheel winch as defined in claim 12 wherein the wheel surface engaging means further includes a circularly shaped mounting member having spaced aligned inside and outside coupling members, which each include a plurality of spaced aligned coupling apertures formed therethrough, the inside coupling member being coupled to the spool at the outer end of the spool nearest the circular shaped end member thereof and the outside coupling member being couplable to the drive wheel.

20. A wheel winch as defined in claim 19 wherein the second elongated means includes a cable having a first slot engaging member at one end thereof for couplingly engaging the cable in the slot of the spool and a second engaging member at another end thereof for coupling the cable to the stationary object.

21. A wheel winch as defined in claim 20 wherein the first slot engaging member is a coupling plug and the second engaging member is a cable hook.

22. A wheel winch as defined in claim 21 wherein the wheel surface engaging coupling means includes:
first portions thereof coupled to the drive wheel of the vehicle for aligned engagement in the apertures in the wheel surface engaging means; and
second portions thereof for coupling to the aligned aperture engagement means so that the surface engaging means is coupled for rotation to the wheel of the vehicle.

23. A wheel winch as defined in claim 22 wherein the first portions of the wheel surface engaging coupling means includes a plurality of spaced threaded studs projecting outwardly from the drive wheel, each one of the studs being alignable in a corresponding one of the apertures in the wheel surface engaging means.

24. A wheel winch as defined in claim 23 wherein the second portions of the wheel surface engaging coupling means includes a plurality of wheel nuts, each one of the wheel nuts being threadedly couplable to a corresponding one of the studs of the wheel surface engaging coupling means so that the wheel surface engaging means is coupled for rotation to the drive wheel of the vehicle.

25. A wheel winch as defined in claim 3 wherein the first elongated means further includes a spool having a longitudinally extending opening formed therethrough a diagonally extending circular end member coupled to one end of the spool, a first support member having threaded apertures formed therein at another end of the spool and a coupling slot formed in an intermediate portion of the spool.

26. A wheel winch as defined in claim 25 wherein the wheel surface engaging means further includes:
a circular shaped mounting member having a plurality of spaced coupling apertures formed therein, couplably aligned adjacent to the wheel; and
a second support member coupled to the mounted member having threaded apertures formed therein, the threaded apertures being aligned in coupling engagement with the threaded apertures first support member in the spool; and
a plurality of threaded bolts, one of which is threadedly coupled in each one of the threaded apertures in the aligned first and second support members to couple them to each other.

27. A wheel winch as defined in claim 26 wherein the second elongated means includes a cable having a first slot engaging member at one end thereof for couplingly engaging the cable in the slot of the spool and a second engaging member at another end thereof for coupling the cable to the stationary object.

28. A wheel winch as defined in claim 27 wherein the first slot engaging member is a coupling plug and the second engaging member is a cable hook.

29. A wheel winch as defined in claim 28 wherein the wheel surface engaging coupling means includes:
first portions thereof coupled to the wheel of the vehicle for aligned engagement in the apertures in the wheel surface engaging means; and
second portions thereof for coupling to the aligned aperture engagement means so that the wheel surface engaging means is coupled for rotation to the drive wheel of the vehicle.

30. A wheel winch as defined in claim 29 wherein the first portions of the wheel surface engaging coupling means includes a plurality of spaced threaded studs projecting outwardly from the wheel, each one of the studs being alignable in a corresponding one of the apertures in the wheel surface engaging means.

31. A wheel winch as defined in claim 30 wherein the second portions of the wheel surface engaging coupling means includes a plurality of wheel nuts, each one of the wheel nuts being threadedly couplable to a corresponding one of the studs of the wheel surface engaging coupling means so that the wheel surface engaging means is coupled for rotation to the drive wheel of the vehicle.

32. A wheel winch as defined in claim 1 further including a guide member couplable to a frame of the automobile to support and guide the second elongated member between the first elongated member and the stationary member when the vehicle is being pulled from a mired condition.

33. A wheel winch as defined in claim 32 wherein the guide member includes:
a first support arm coupled to the automobile frame;
a second support arm perpendicularly coupled to the first support arm;
a third support arm diagonally coupled between the first and second support arms; and
a guide member coupled to the second support arm for mounting the second elongated member along a predetermined path as the elongated member is moved therethrough as the vehicle is being moved from the mired condition.
